(19) United States
(12) Patent Application Publication
(10) Pub. No.: US 2011/0303432 A1
(43) Pub. Date: Dec. 15, 2011

(54) POWER TOOL TRANSMISSION

(76) Inventors: Joseph G. Stauffer, Conowingo, MD (US); Aris C. Cleanthous, Baltimore, MD (US); Sankarshan Murthy, Towson, MD (US); John Zellinger, Middle River, MD (US); Qiang J. Zhang, Lutherville, MD (US)

(21) Appl. No.: 13/154,712

(22) Filed: Jun. 7, 2011

Related U.S. Application Data
(60) Provisional application No. 61/354,492, filed on Jun. 14, 2010.

(51) Int. Cl. B23Q 15/00; B25F 5/00

(52) U.S. Cl. 173/181; 173/47

(57) ABSTRACT

A power tool that includes a housing assembly, a motor received in the housing assembly, a trigger, an output spindle, a transmission and a bearing. The transmission is received in the housing assembly and transmits rotary power between the motor and the output spindle. The transmission has an output planetary stage with an output planet carrier. The transmission also has a member that is axially movable between a first position, which causes the transmission to operate in a first speed ratio, and a second position in which the transmission operates in a second speed ratio that is different than the first speed ratio. The bearing is disposed radially between and engages both the housing assembly and the output planet carrier. The output spindle is at least partially received into the output planet carrier such that the bearing indirectly supports the output spindle.

### CROSS-REFERENCE TO RELATED APPLICATIONS

This application claims the benefit of U.S. Provisional Patent Application No. 61/354,492 entitled “Power Tool Transmission” filed Jun. 14, 2010, the disclosure of which is hereby incorporated by reference as if fully set forth in detail herein.

### FIELD

The present disclosure relates to a power tool transmission and a power tool incorporating same.

### BACKGROUND

U.S. Pat. Nos. 6,431,289 and 7,066,691 disclose relatively compact multi-speed drill/drivers. U.S. Pat. No. 6,431,289 employs a multi-speed transmission in which an output planet carrier is journally supported by a spindle lock mechanism. U.S. Pat. No. 7,066,691 employs a multi-speed transmission in which an output planet carrier is supported by a bearing that is mounted to an output spindle. While such drill/drivers are well designed for their intended purpose, we have found it would be desirable in some instances to provide a drill/driver that was relatively more compact in an axial direction (i.e., along a rotational axis of the output spindle).

### SUMMARY

This section provides a general summary of the disclosure, and is not a comprehensive disclosure of its full scope or all of its features.

In one form, the present teachings provide a power tool that includes a housing assembly, a motor received in the housing assembly, a trigger, an output spindle, a transmission and a bearing. The housing assembly has a handle. The trigger is coupled to the housing assembly and is configured to receive a manual input from a user of the power tool to control operation of the motor. The transmission is received in the housing assembly and transmits rotary power between the motor and the output spindle. The transmission has an output planetary stage with an output planet carrier. The transmission also has a member that is axially movable between a first position, which causes the transmission to operate in a first speed ratio, and a second position in which the transmission operates in a second speed ratio that is different than the first speed ratio. The bearing is disposed radially between and engages both the housing assembly and the output planet carrier. The output spindle is at least partially received into the output planet carrier such that the bearing indirectly supports the output spindle.

In another form, the present teachings provide a power tool that includes a housing assembly, a motor received in the housing assembly, a trigger, an output spindle, a transmission and a bearing. The housing assembly has a handle. The trigger is coupled to the housing assembly and is configured to receive a manual input from a user of the power tool to control operation of the motor. The transmission is received in the housing assembly and transmits rotary power between the motor and the output spindle. The transmission has an output planetary stage with an output planet carrier. The transmission also has a member that is axially movable between a first position, which causes the transmission to operate in a first speed ratio, and a second position in which the transmission operates in a second speed ratio that is different than the first speed ratio. The bearing is disposed radially between and engages both the housing assembly and the output planet carrier. The bearing supports both the output planet carrier and the output spindle. A plane taken through the center of the bearing perpendicular to a rotational axis of the output spindle intersects the trigger.

In the above-two examples, a portion of the anvil can be received within and rotatably supported by the output planet carrier such that at least a portion of the anvil overlaps the bearing in an axial direction. The output planet carrier can comprise an aperture having a plurality of lands that contact the portion of the anvil in circumferentially spaced-apart locations.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a portion of a longitudinal section view of an exemplary power tool constructed in accordance with the teachings of the present disclosure;

FIG. 2 is a view similar to FIG. 1 but illustrating the transmission of the power tool of FIG. 1 in a second speed ratio;

FIG. 3 is a partial exploded view illustrating a portion of the power tool of FIG. 1; and

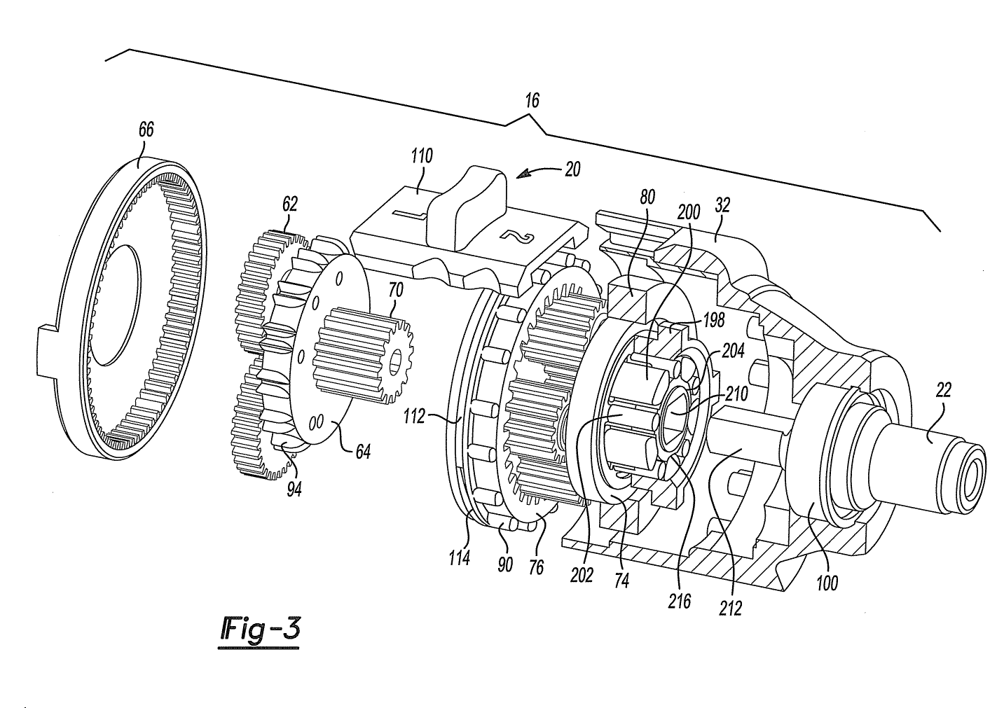

FIG. 4 is a perspective, longitudinally sectioned view of a portion of the power tool of FIG. 1 illustrating the nesting of an anvil of a spindle lock within an output planet carrier.

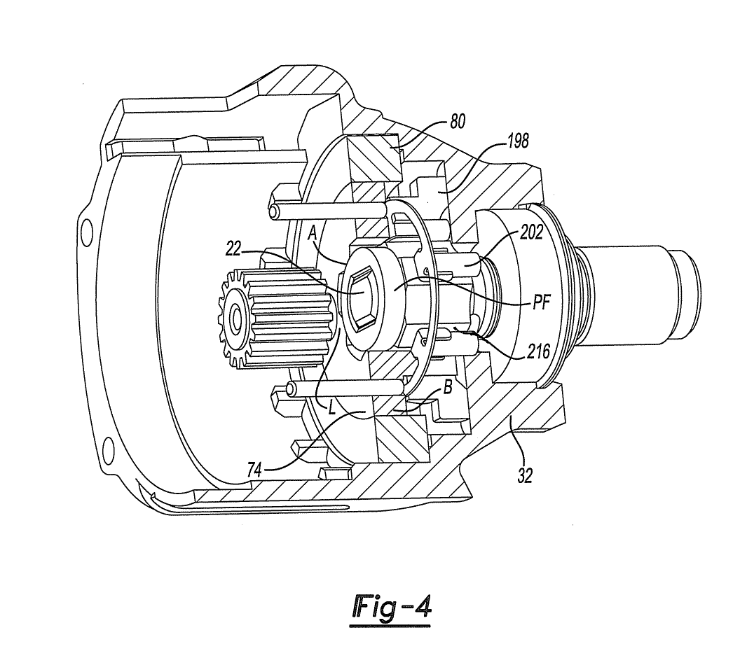

Corresponding reference numerals indicate corresponding parts throughout the several views of the drawings.

### DETAILED DESCRIPTION

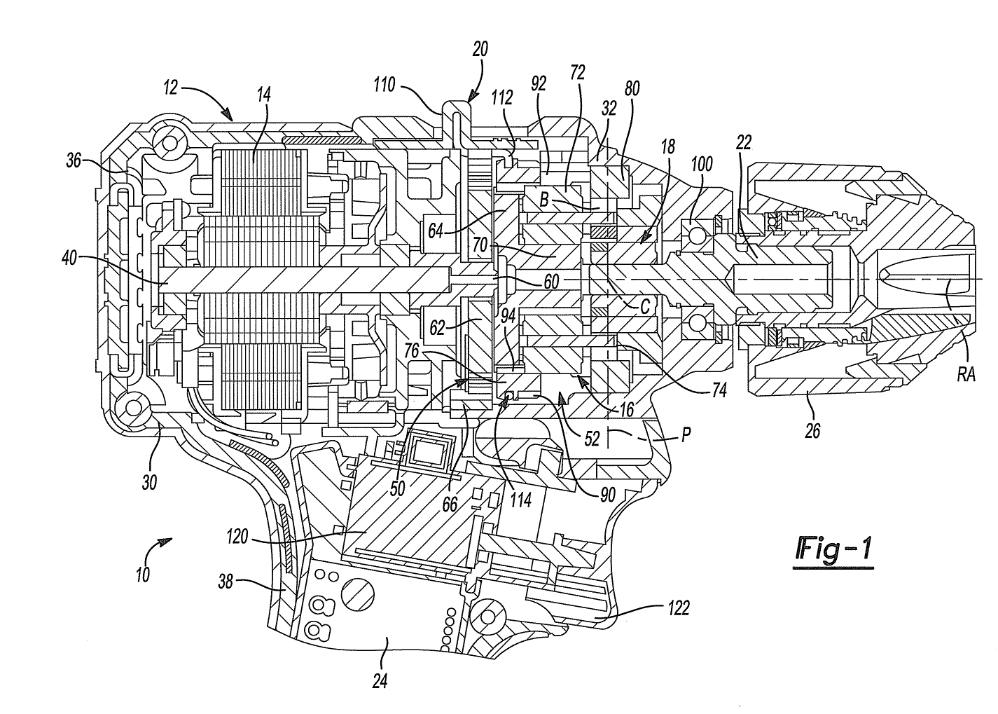

With reference to the FIG. 1, a power tool constructed in accordance with the teachings of the present disclosure is illustrated in longitudinal cross-section and identified by reference numeral 10. The power tool 10 in the particular example provided is a drill/driver, but it will be appreciated that the teachings of the present disclosure have application to various other types of power tools and moreover that the output of the power tool driven (at least partly) by a transmission constructed in accordance with the teachings of the present disclosure need not be in a rotary direction.

The power tool 10 can include a housing assembly 12, a motor 14, a transmission 16, a spindle lock 18, a speed selector 20, an output spindle 22, a controller 24, and a chuck 26 that can be coupled for rotation with the output spindle 22. The housing assembly 12 can include a housing 30 and a gear case 32 that can be removably coupled to the housing 30. The housing 30 can define a housing body 36 and a handle 38.

The motor 14 can be received in the housing body 36 and can include an output shaft 40 that can provide a rotary input to the transmission 16. The motor 14 can be any type of motor and can be powered by an appropriate power source (electricity, pneumatic power, hydraulic power). In the particular example provided, the motor 14 is a brushless DC electric motor and is powered by a battery pack (not shown).

The transmission 16 can be a two-stage, two-speed transmission and can be received in the gear case 32. The transmission 16 can have a first or input planetary stage 50 and a second or output planetary stage 52 that cooperate to drive the output spindle 22. The first or planetary stage 50 can include an input sun gear 60, a set of first planetary gears 62, an input planet carrier 64, and a first ring gear 66, which the second planetary stage 52 can include an output sun gear 70, a set of second planetary gears 72, an output planet carrier 74 and a second ring gear 76.

The input sun gear 60 can be coupled to the output shaft 40 for rotation therewith. The first planetary gears 62 can be journally supported by the input planet carrier 64 (e.g., on pins that extend rearwardly from the body of the input planet carrier 64) and meshingly engaged to both the input sun gear 60 and the first ring gear 66. The first ring gear 66 can be non-rotatably coupled to the housing 30.

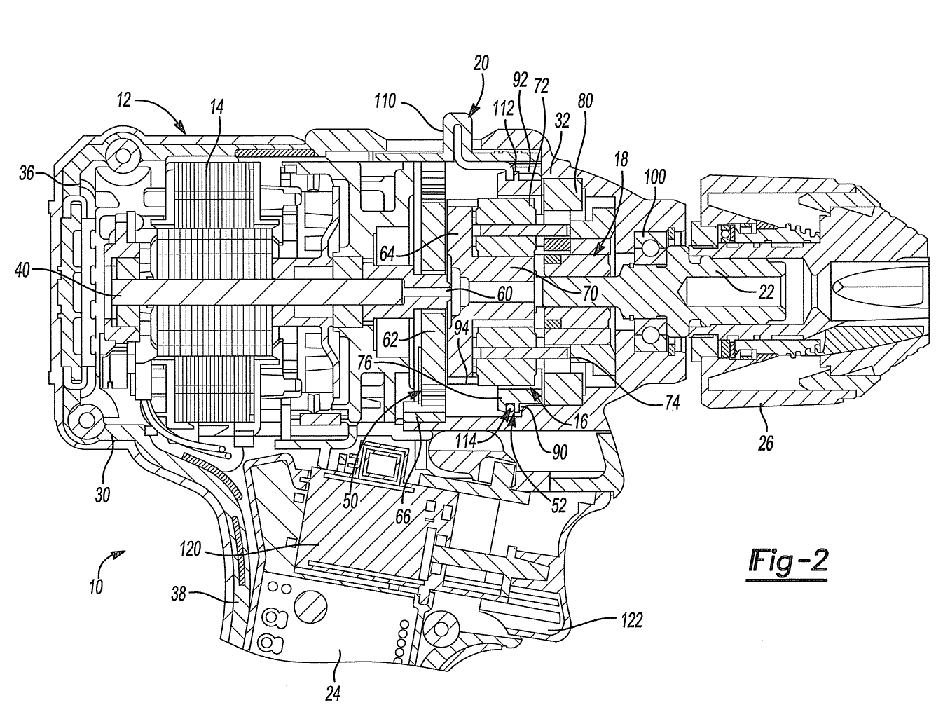

The output sun gear 70 can be coupled to the input planet carrier 64 for rotation therewith. The second planetary gears 72 can be journally supported by the output planet carrier 74 (e.g., on pins that extend rearwardly from the body B of the output planet carrier 74) and meshingly engaged to both the output sun gear 70 and the second ring gear 76. A rear bearing 80, which can be any type of bearing or bushing, such as a rolling element bearing or a journal bearing, can be employed to support the output planet carrier 74 for rotation within the housing 30. The second ring gear 76 can be axially movably mounted within the gear case 32 so as to be movable between a first position, in which the second ring gear 76 is non-rotatably mounted to the gear case 32 and meshingly engaged with only the second planetary gears 72 as shown in FIG. 2, and a second position in which the second ring gear 76 is not engaged to the gear case 32 (i.e., is rotatable relative to the gear case 32), is meshingly engaged with the second planetary gears 72 and is non-rotatably coupled to the input planet carrier 64 as shown in FIG. 1. In the particular example provided, the second ring gear 76 includes a set of external teeth 90 that extend about its perimeter that are engagable to corresponding teeth 92 formed on the interior of the gear case 32, while the input planet carrier 64 includes a toothed perimeter 94 that may be engaged by the internal teeth of the second ring gear 76. It will be appreciated, however, that various other means may be employed to non-rotatably couple the second ring gear 76 to the gear case 32 and/or the input planet carrier 64 and as such, the particular example illustrated will not be deemed as limiting the scope of the present disclosure.

Rotary power output from the transmission 16 is transmitted through the spindle lock 18 to the output spindle 22 (i.e., the spindle lock 18 is disposed in a torque path between the second planetary stage 52 and the output spindle 22). The spindle lock 18 can be conventional in its construction and operation and as such, need not be described in significant detail herein. Briefly, the spindle lock 18 can include an outer collar 198, a plurality of drive members 200, which can be coupled to the output planet carrier 74, a plurality of pins 202, and an anvil 204. The outer collar 198 can be non-rotatably coupled to the gear case 32 and can be disposed about the drive members 200 and the pins 202. The anvil 204 can define a central aperture 210 for receiving a corresponding end 212 of the output spindle 22, as well as a plurality of anvil surfaces 216 that are disposed on a side of the pins 202 opposite the outer collar 198. The spindle lock 18 is configured to permit the transmission of rotary power between the transmission 16 and the output spindle 22 when the rotary power flows from the transmission 16 to the output spindle 22, but does not permit rotary power to be transmitted from the output spindle 22 to the transmission 16. As is known, the spindle lock 18 permits the transmission 16 to drive the output spindle 22 but locks the output spindle 22 to the housing assembly 12 to prevent the output spindle 22 from being rotated manually. The anvil 204 can comprise a pilot feature PF, such as a cylindrically shaped segment, that can be received into a aperture A in the body B of the output planet carrier 74. The aperture A and the pilot feature PF can be configured such that the output planet carrier 74, which is supported for rotation relative to the gear case 32 via the rear bearing 80, will support an axial end of the anvil 204 for rotation relative to the output planet carrier 74. Construction in this manner permits the anvil 204 to partially overlap the rear bearing 80 in an axial direction (i.e., along the rotational axis of the output spindle 22) to reduce the overall length of the power tool 10. The aperture A can be formed so as to support the pilot feature PF at several, circumferentially spaced-apart locations (e.g., via a plurality of circumferentially spaced apart lands L having a cylindrical inside surface for contacting the pilot feature PF) to thereby reduce the contact between the output planet carrier 74 and the anvil 204.

A front bearing 100, which can be a bearing or a bushing, can be employed to support a front end of the output spindle 22 for rotation relative to the housing assembly 12, as well as support the output spindle 22 in an axial direction. The bearing arrangement provided in the power tool 10 permits the output planet carrier 74, the rear bearing 80 and the spindle lock 18 to overlap in an axial direction.

The speed selector 20 can comprise a switch member 110 and an actuator 112. The switch member 110 can be movably coupled to the housing assembly 12 and in the particular example provided, includes a slider that is axially movably mounted to the housing assembly 12. The actuator 112 can couple the switch member 110 to the second ring gear 76 and in the particular example provided, comprises a wire clip that is received into an annular groove 114 formed in the perimeter of the second ring gear 76. The wire clip can have various different shapes, for example two quarter-moon shapes, that cooperate to distribute a translating force received from the switch member 110 over a pair of sectors of the second ring gear 76. Other examples include the formation of the wire clip in a half-moon shape or with one or more tabs that extend radially into the annular groove 114.

It will be appreciated that the speed selector 20 can be employed to move the second ring gear 76 between the first position, which causes the transmission 16 to operate at a first speed ratio, and the second position, which causes the transmission 16 to operate at a second speed ratio.

The controller 24 can be employed to control the operation of the motor 14. In the present example, the controller 24 is mounted in the handle 38 and comprises a variable speed switch 120 that is activated by a trigger 122. It will be appreciated, however, that the controller 24 could include other functionality, such as a torque monitoring and/or shut-off capability. For example, the controller 24 could be configured to monitor current draw and to inactivate the motor 14 in response to the application of a pre-set or user set-able current level. As another example, a torque sensor, such as an eddy current torque sensor, could be integrated into the power tool 10 and could provide feedback to the controller 24 that could be used to monitor the output torque of the power tool 10 and/or to halt the operation of the power tool 10 at a predetermined torque. As another alternative, a clutch could be integrated into the power tool 10. The clutch could be a mechanical clutch of the type disclosed in U.S. Pat. Nos. 6,431,289 and 7,066,691, the disclosures of which are hereby incorporated by reference as if fully set forth in detail herein. The clutch disclosed in U.S. Pat. No. 6,431,289 would be compatible with the transmission 16 as it is currently configured, except that the first ring gear 66 would be rotatable relative to the housing assembly 12 and the clutch would be configured to inhibit rotation of the first ring gear 66 relative to the housing assembly 12 unless the torque output from the power tool 10 exceeded a set or settable clutch torque. The clutch disclosed in U.S. Pat. No. 7,066,691 could be mounted between the motor 14 and the transmission 16 and would be compatible with the transmission as it is currently configured, except that the first ring gear 66 would be rotatable relative to the housing assembly 12 and the clutch would be configured to inhibit rotation of the first ring gear 66 relative to the housing assembly 12 unless the torque output from the power tool 10 exceeded a set or settable clutch torque. Alternatively, the transmission 16 could be reversed (so that the second planetary stage 52 is the input stage and receives torque directly from the motor 14, while the first planetary stage 50 is the output stage and outputs rotary power through the spindle lock 18 to the output spindle 22) so that the clutch could be located on the front of the power tool 10 in a more conventional manner. It will be appreciated that in this latter arrangement, the first ring gear 66 would be rotatable relative to the housing assembly 12 and the clutch would be configured to inhibit rotation of the first ring gear 66 relative to the housing assembly 12 unless the torque output from the power tool 10 exceeded a set or settable clutch torque.

With specific reference to FIG. 1, a plane P taken through the center C of the bearing 80 perpendicular to the rotational axis RA of the output spindle 22 is shown to intersect the body B of the output planet carrier 74, the output spindle 22 and the trigger 122. In contrast, the output spindle of each of the power tools disclosed in U.S. Pat. Nos. 6,431,289 and 7,066,691 is illustrated to be forward of the trigger of the associated drill/driver. Accordingly, those of skill in the art will appreciate from this disclosure that a power tool constructed in accordance with the teachings of the present disclosure can be more compact in an axial direction as compared to other power tools known in the art.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A power tool comprising:
a housing assembly having a handle;
a motor received in the housing assembly;
a trigger coupled to the housing assembly and operable for receiving a manual input from a user of the power tool to control operation of the motor;
an output spindle;
a transmission received in the housing assembly and transmitting rotary power between the motor and the output spindle, the transmission comprising an output planetary stage that comprises an output planet carrier, wherein the transmission has a member that is axially movable between a first position, which causes the transmission to operate in a first speed ratio, and a second position in which the transmission operates in a second speed ratio that is different than the first speed ratio; and
a bearing disposed radially between and engaging both the housing assembly and the output planet carrier;
wherein the output spindle is at least partially received into the output planet carrier such that the bearing indirectly supports the output spindle.

2. The power tool of claim 1, further comprising a spindle lock disposed in a torque path between the output planetary stage and the output spindle.

3. The power tool of claim 2, wherein the spindle lock at least partly overlaps the bearing and the output planet carrier in the axial direction.

4. The power tool of claim 1, further comprising a controller coupled to the motor and configured to halt operation of the motor in response to the sensing of a parameter indicative of transmission of an output torque of a predetermined magnitude through the output spindle.

5. The power tool of claim 1, further comprising a controller coupled to the motor and configured to control the motor to limit rotation of the output spindle after a torque of a predetermined magnitude has been transmitted between the transmission and the output spindle.

6. The power tool of claim 5, wherein the controller halts rotation of the output spindle after the torque of the predetermined magnitude has been transmitted between the transmission and the output spindle.

7. The power tool of claim 1, wherein the bearing is a bushing.

8. The power tool of claim 1, wherein the transmission comprises an input planetary stage that receives rotary power from the motor and transmits rotary power directly to the output planetary stage.

9. The power tool of claim 1, wherein the output planet carrier comprises a carrier body and a plurality of pins, each of the pins being configured to journally support an associated output planet gear and being fixedly coupled to the carrier body, the carrier body being received in the bearing.

10. The power tool of claim 1, wherein a plane taken through the center of the bearing perpendicular to a rotational axis of the output spindle intersects the trigger.

11. The power tool of claim 1, wherein the spindle lock comprises an anvil and wherein a portion of the anvil is received within and rotatably supported by the output planet carrier such that at least a portion of the anvil overlaps the bearing in an axial direction.

12. The power tool of claim 11, wherein the output planet carrier comprises an aperture having a plurality of lands that contact the portion of the anvil in circumferentially spaced-apart locations.

13. A power tool comprising:
a housing assembly having a handle;
a motor received in the housing assembly;
a trigger coupled to the housing assembly and operable for receiving a manual input from a user of the power tool to control operation of the motor;
an output spindle;
a transmission received in the housing assembly and transmitting rotary power between the motor and the output spindle, the transmission comprising an output planetary stage that comprises an output planet carrier, wherein the transmission has a member that is axially movable between a first position, which causes the transmission to operate in a first speed ratio, and a second position in which the transmission operates in a second speed ratio that is different than the first speed ratio; and
a bearing disposed radially between and engaging both the housing assembly and the output planet carrier, the bearing supporting both the output planet carrier and the output spindle;
wherein a plane taken through the center of the bearing perpendicular to a rotational axis of the output spindle intersects the trigger.

14. The power tool of claim 13, further comprising a spindle lock disposed in a torque path between the output planetary stage and the output spindle.

15. The power tool of claim 14, wherein the spindle lock at least partly overlaps the bearing and the output planet carrier in the axial direction.

16. The power tool of claim 14, wherein the spindle lock comprises an anvil and wherein a portion of the anvil is received within and rotatably supported by the output planet carrier such that at least a portion of the anvil overlaps the bearing in an axial direction.

17. The power tool of claim 16, wherein the output planet carrier comprises an aperture having a plurality of lands that contact the portion of the anvil in circumferentially spaced-apart locations.

18. The power tool of claim 13, further comprising a controller coupled to the motor and configured to halt operation of the motor in response to the sensing of a parameter indicative of transmission of an output torque of a predetermined magnitude through the output spindle.

19. The power tool of claim 13, further comprising a controller coupled to the motor and configured to control the motor to limit rotation of the output spindle after a torque of a predetermined magnitude has been transmitted between the transmission and the output spindle.

20. The power tool of claim 19, wherein the controller halts rotation of the output spindle after the torque of the predetermined magnitude has been transmitted between the transmission and the output spindle.

21. The power tool of claim 13, wherein the bearing is a bushing.

22. The power tool of claim 13, wherein the transmission comprises an input planetary stage that receives rotary power from the motor and transmits rotary power directly to the output planetary stage.

23. The power tool of claim 13, wherein the output planet carrier comprises a carrier body and a plurality of pins, each of the pins being configured to journally support an associated output planet gear and being fixedly coupled to the carrier body, the carrier body being received in the bearing.

24. A power tool comprising:
a housing assembly having a handle;
a motor received in the housing assembly;
a trigger coupled to the housing assembly and operable for receiving a manual input from a user of the power tool to control operation of the motor;
an output spindle;
a transmission received in the housing assembly and transmitting rotary power between the motor and the output spindle, the transmission comprising an output planetary stage that comprises an output planet carrier, wherein the transmission has a member that is axially movable between a first position, which causes the transmission to operate in a first speed ratio, and a second position in which the transmission operates in a second speed ratio that is different than the first speed ratio;
a bearing disposed radially between and engaging both the housing assembly and the output planet carrier, wherein the output spindle is at least partially received into the output planet carrier such that the bearing indirectly supports the output spindle; and
a spindle lock disposed in a torque path between the output planetary stage and the output spindle, wherein the spindle lock at least partly overlaps the bearing and the output planet carrier in the axial direction;
wherein the output planet carrier comprises a carrier body and a plurality of pins, each of the pins being configured to journally support an associated output planet gear and being fixedly coupled to the carrier body, the carrier body being received in the bearing;
wherein a plane taken through the center of the bearing perpendicular to a rotational axis of the output spindle intersects the trigger;
wherein the spindle lock comprises an anvil, and wherein a portion of the anvil is received within and rotatably supported by the output planet carrier such that at least a portion of the anvil overlaps the bearing in an axial direction; and
wherein the output planet carrier comprises an aperture having a plurality of lands that contact the portion of the anvil in circumferentially spaced-apart locations.
